(19) United States
(12) Patent Application Publication
(10) Pub. No.: US 2016/0088949 A1
(43) Pub. Date: Mar. 31, 2016

(54) Vehicle Seat Cover with Additional Uses

(71) Applicant: David Mitchell Yakubyak, San Francisco, CA (US)

(72) Inventor: David Mitchell Yakubyak, San Francisco, CA (US)

(21) Appl. No.: 14/499,126

(22) Filed: Sep. 27, 2014

(51) Int. Cl. A47C 7/72; B60R 11/02; B60N 2/60

(52) U.S. Cl. CPC A47C 7/72; B60N 2/60; B60R 11/0217; B60R 11/0247

(57) ABSTRACT

A vehicle seat characterized by the addition of a voice activated command system for electronically communicating through a car seat cover. An electronically controlled apparatus is embedded behind an image displayed on the back side of the car seat cover. The car seat cover contains a feature of a first personalized image displayed on the front and a second personalized image on the rear side of the seat cover. When the image is displayed on the rear side facing the rear seat passenger, a voice activated electronic command apparatus behind the image of the car seat cover allows the driver to speak and communicate with the rear seat passenger such as a child. The electronic communication device conveys the driver's words to the rear seat passengers through the car seat cover's rear displayed image.

### FIELD OF THE INVENTION

The present invention generally relates to the field of design and technology of seat covers for various seat configurations. More particularly, the invention relates to a seat cover with a function which enables the front seat driver to communicate with the rear seat passenger through a voice activated electronic apparatus.

### BACKGROUND OF THE INVENTION

Seat covers have been widely used for commercial applications and various purposes including to store, cover, and protect seats. Seat covers for vehicles have been designed and manufactured with various materials such as plastic, wool, vinyl, leather, and many other types of material depending on the user's necessities. More particularly, seat covers for vehicles have been designed and used for other purposes to maintain and restore the original surface of the seat. Including maintaining and restoring seats for vehicles, seat covers have proven to be a fashion statement for vehicle owners as well. For years designs and patterns have been implemented for expressing fashionable trends on the seats of vehicles. Popularity has risen in the use and application of seat covers since the original invention. The implementation of images on seat covers has proven to be a major success as vehicle owners have added a creative addition for the vehicle seats. Images of various cartoon characters, famous actors and actresses, logos for sports teams, and a prodigious number of other displays have been implemented on car seats for fashion and entertainment purposes.

While car seat covers allow users the protection, restoration, and fashionable trends to be displayed on the vehicles, seat covers allow for another advantageous purpose concerning safety pertaining to driving vehicles. A leading cause of car accidents in the United States is created by the children's distraction of the driver while seated in the rear seats. Children perpetually require their parents' attention and comfort, especially when seated in the rear seats in isolation without the ability to visually see their mother, father, or guardian. As parent's react to the child in the rear seats, the focus is turned away from the road and accidents occur commonly from diverted attention of the road. While previous inventions exist pertaining to visual images on car seats, the ability to electronically communicate through car seats with other members in the vehicle have not been presented to commercial markets. The ability to electronically communicate voice recognized sounds through the car seat to other members of the vehicle, especially those who have children sitting in the rear seats can prove to be a helpful assist with communication between a driver and a child in a vehicle, helping child to remain calm, while the parent can remain focused on the road. Coupling the image of the parent's displayed image on the rear side of the car seat and electronically communicating language through the car seat enables to the children allows the child feel a sense of comfort while traveling in a car. In turn, this also allows the driver to drive with caution while maintaining focus on the road.

### SUMMARY OF THE INVENTION

Present car seat covers enable a feature which allows images to be displayed on the front and rear of the car seat cover. This allows for a creative way to design and fashion the car seat cover for user interests. One advantage to the image displayed car seat cover in particular lies in the safety and comfort of the driver while driving with children in the rear seats. An image displayed on the rear side of a seat cover allows for the back seat passengers such as children or babies to view an image of their parents while the parent is driving the vehicle. The image of the parents can allow the children to remain comfortable while traveling in the car. In many cases, a child requires the attention of the parent while seated in isolation in the rear seat. The parents can be distracted from the road to divert attention to tend to the child's requests. There are safety concerns involving situations where the parent's lose focus on the road to tend to children while driving. Yet while the image of the parent displayed on the rear car seats allows the children to visually see the parent, the present invention takes the car seat cover image feature and adds a novel apparatus of electronic communication, by adding an electronically controlled voice command included in the car seat cover behind the rear side image. When adding the feature of an electronically controlled voice command to the image of the parent, on the rear side of the car seat cover, the parent will have the ability to simultaneously drive and communicate to the child in the rear seat. The parent can avoid accidents by giving attention on the road without having to physically turn and adjust to provide attention on the children.

Features and advantages of the improved invention will appear from the following description in which the preferred embodiment has been set forth in detail in conjunction with the accompanying drawings

### BREIF DESCRIPTION OF THE DRAWINGS

FIG. 1 is a perspective view of the car seat 100 displayed representing the shape of a car seat.

FIG. 2 is a hashed line depiction of the car seat cover embedded around the car seat with 110 displaying the back side of the car seat cover while 111 is displaying the seated area for the legs of the driver.

FIG. 3 is a hashed line depiction of the car seat cover embedded around the car seat with 110 and 111 representing the car seat cover. 120 is a representation of the image location featured on the car seat cover for the front side of the car seat cover.

FIG. 4 is a representation of an image on the rear side of the car seat cover 130. The hash tagged line is the car seat cover placed over the car seat.

FIG. 5 is a side view of the car seat with the car seat cover in hash tagged line depiction. 140 is the electronic command apparatus embedded into the car seat cover as to represent the voice commands presented behind the image displayed on the rear side of the car seat cover.

FIG. 6 is the electronic voice command feature displayed on a front view. 150 is the speaker system embedded behind the image display for the voice activated commands to be conveyed from the voice of the driver sitting in the front driver seat.

### DETAILED DESCRIPTION OF THE DRAWINGS

While the present invention may be embodied in many different shapes, forms, sizes, colors, designs or configurations, for the purpose of promoting an understanding of the principles of the invention, reference will be made to the embodiments illustrated in the drawings and specific language will be used to describe the same. It will nevertheless be understood that no limitation of the scope of the invention is thereby intended. Any alterations and further implementations of the principle, the essence or the spirit of the invention as described herein are contemplated as would normally occur to one skilled in the art to which the invention relates.

Disclosed herein is a car seat cover for placing over the front driver seat of a vehicle. The seat cover includes an envelope with a shape that is well adapted to the car seat's exterior shape, a first personalized image being printed on the envelope's front side, and a second personalized image being printed on the envelope's back side. Preferably, the envelope is made of elastic textile.

In another embodiment of the invention, the car seat cover further includes an electronic device for communicating between a front seat driver and a rear seat passenger. The electronic device includes a wireless headset electronically coupled to a speaker and a microphone. The speaker and the microphone are placed behind the second personalized image of the envelope. The second personalized image can be any image, such as mom's face image, which attracts the rear seat passengers' attention. In a situation where the front seat driver is a mom and the rear seat passengers are children, when driving, the image of the mom's face and the mom's voice from the mom's image attract the children's attention. In this way, the driver does not need to turn her head to talk to the children. This will greatly increase of the driving safety.

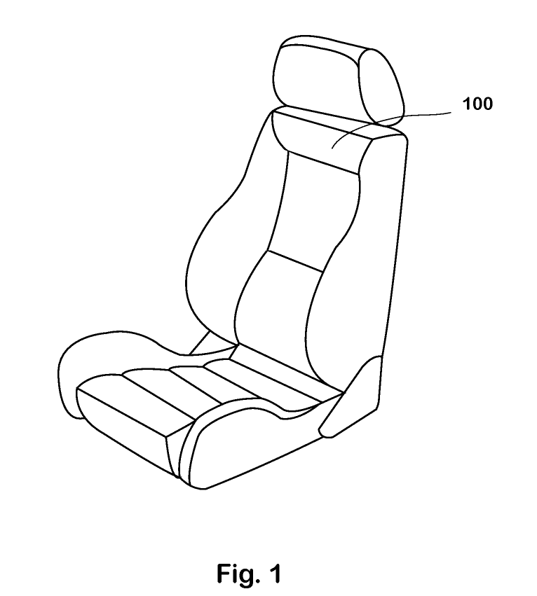

Illustrated in FIG. 1 is a perspective view of the car seat 100 representing one style of a car seat. It should be noted that car seats can be formed and shaped into different styles and this car seat shape is one of many styles that is presented for representation of the invention.

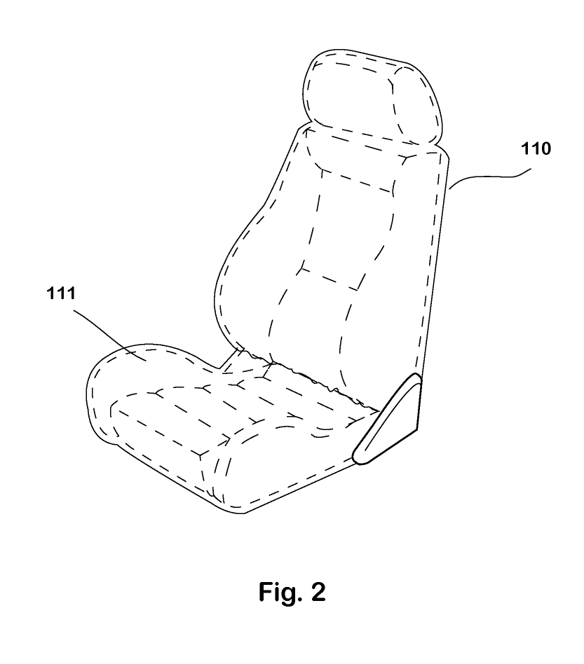

Illustrated in FIG. 2 is a perspective view of a specific style of car seat. The hashed line is a representation of a car seat cover that may be utilized on the car to demonstrate the invention. 111 and 110 are indicators initiating the areas of the car seat where the cover seat cover can be applied for the purpose of the invention.

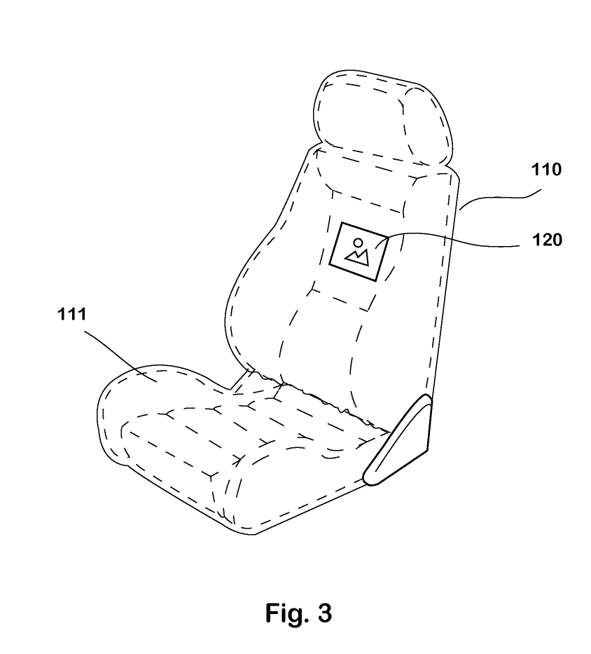

Illustrated in FIG. 3 is a hashed line depiction of the car seat cover embedded around the car seat with 110 and 111 representing the car seat cover. 120 is a representation of the image location featured on the car seat cover for the front side of the car seat cover. Present inventions of image displayed features on car seat covers include the images on the front side. The size and shape of the image can vary depending on the user's interest. In this position the driver will be resting the back against the image and the image will not be visible while the driver is seated to operate the vehicle.

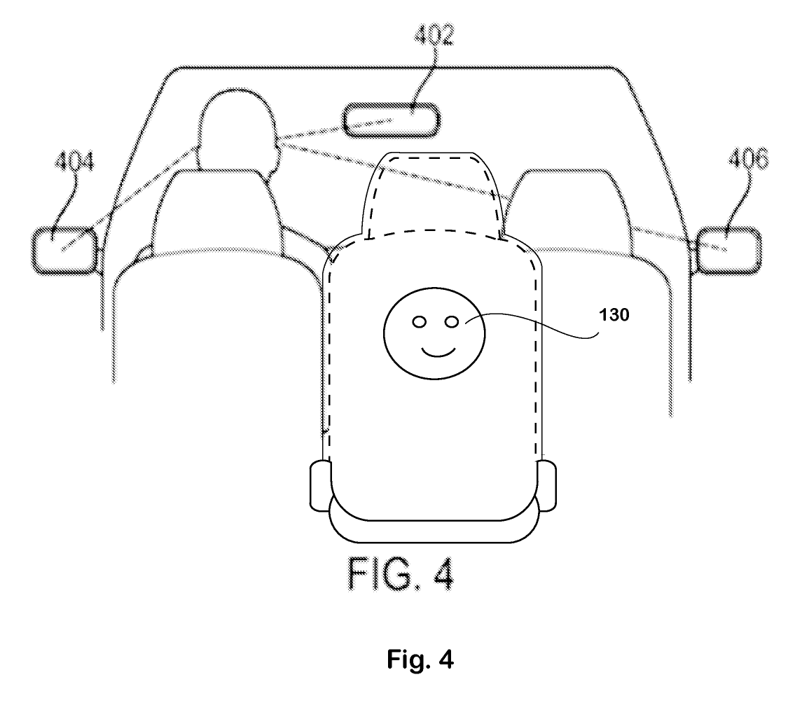

Illustrated in FIG. 4 is a representation of an image on the rear side of the car seat cover 130. The hash tagged line is the car seat cover placed over the car seat. In this image, the passenger of the vehicle such as a child can visually view the picture of the parent. The image of the parent can be displayed on the rear side of the seat cover. Often times, this can cause the child to feel comfort and relaxation while seated in isolation in the rear seat of a vehicle.

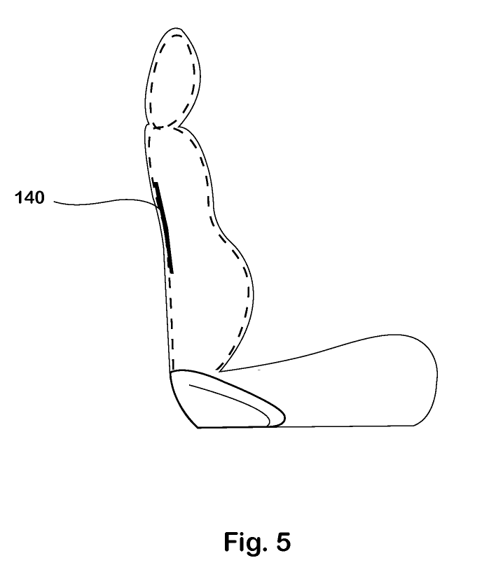

Illustrated in FIG. 5 is a side view of the car seat with the car seat cover in hash tagged line depiction. The novel invention of the voice activated device is depicted. 140 is the electronic command apparatus embedded into the car seat cover as to represent the voice commands presented behind the image displayed on the rear side of the car seat cover. As the driver is focused on driving and the road, the child may be seated in the rear view seat of the vehicle. The invention allows the driver to speak without having to physically turn the body to communicate with the child. If a child is requiring the attention of the driver, the driver has the ability to speak to the child while the words are conveyed through the car seat cover's electronic command device. The electronic command device is implemented behind the image of the parent on the rear side of the car seat cover. The child can obtain a feeling of comfort knowing that parent's voice and image is simultaneously presented by viewing the rear side of the car seat cover. The combination of voice activated communication and image display on the rear side of the seat cover, in turn, allows for a valuable safety measure to be implemented by parents during driving as well.

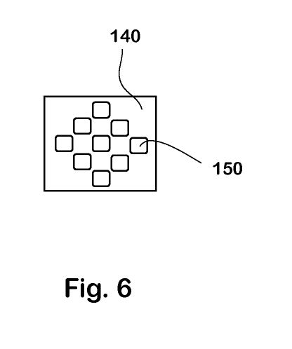

Illustrated FIG. 6 is the electronic voice command feature displayed on a front view. 150 is the speaker system embedded behind the image display on the rear side of the car seat cover for the voice activated commands to be conveyed from the voice of the driver to a child in the rear seat. The electronic voice command apparatus is not visible as the feature is embedded behind the image 140. The voice commands are expressed through the image 140 to the passenger such as a child in the rear seat.

One skilled in the art of web page design will further appreciate the features and combinations from the above described embodiments. Accordingly, the invention should not be limited by what has been particularly shown and described, unless indicated by the claims. All publications and references cited herein are expressly incorporated herein by reference in their entirety.

1. A seat cover for placing over the front driver seat of a vehicle, comprising: an envelope with a shape that is well adapted to said driver seat's exterior shape, a first personalized image being printed on said envelope's front side, and a second personalized image being printed on said envelope's back side.

2. The seat cover of claim 1, wherein said envelope is made of elastic textile.

3. The seat cover of claim 1, further comprising an electronic device for communicating between a front seat driver and a rear seat passenger, wherein said electronic device comprises a wireless headset electronically coupled to a speaker and a microphone, said speaker and said microphone being placed behind said second personalized image of said envelope.
